(19) United States
(12) Patent Application Publication
(10) Pub. No.: US 2006/0101846 A1
(43) Pub. Date: May 18, 2006

(54) Refrigerant filtering apparatus for air conditioners

(75) Inventors: Sung Hwan Kim, Seoul (KR); Jae Heuk Choi, Seoul (KR); Baik Young Chung, Incheon-si (KR); Se Dong Chang, Gwangmyeong-si (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/263,967

(22) Filed: Nov. 2, 2005

(30) Foreign Application Priority Data
Nov. 12, 2004 (KR) P2004-0092369

(51) Int. Cl. F25B 43/00; B01D 46/00

(52) U.S. Cl. 62/474; 55/490

(57) ABSTRACT

Disclosed herein is a refrigerant filtering apparatus for air conditioners that is capable of filtering refrigerant to remove foreign matter therefrom. The refrigerant filtering apparatus comprises a refrigerant flow channel, a filtering net formed in the shape of a cone and mounted in the refrigerant flow channel, such that the apex part of the filtering net is placed at the upstream side in the refrigerant flow direction while the circumferential part of the filtering net is placed at the downstream side in the refrigerant flow direction, for filtering refrigerant to separate foreign matter therefrom, the filtering net being constructed such that the foreign matter is gathered in the vicinity of the connection between the filtering net and the refrigerant flow channel, and a sludge cup for collecting the foreign matter, the sludge cup being detachably attached to the refrigerant flow channel.

This application claims the benefit of Korean Patent Application No. 2004-0092369, filed on Nov. 12, 2004, which is hereby incorporated by reference as if fully set forth herein.

### BACKGROUND OF THE INVENTION

1. Field of the Invention

The present invention relates to an air conditioner, and more particularly, to a refrigerant filtering apparatus for air conditioners that is capable of filtering refrigerant to remove foreign matter therefrom.

2. Discussion of the Related Art

Generally, an air conditioner is an apparatus used to cool or heat the interiors of houses, restaurants or office rooms. The air conditioner comprises an indoor unit and an outdoor unit. The indoor and outdoor units are connected to each other via a refrigerant flow channel, through which refrigerant flows between the indoor and outdoor units. Also, the outdoor unit has a compressor for compressing the refrigerant.

While flowing between the indoor and outdoor units through the refrigerant flow channel, the refrigerant absorbs or emits heat, based on phase change of the refrigerant, to control the temperature of indoor air. When the air conditioner is operated in cooling mode, for example, the refrigerant is evaporated in the indoor unit to absorb heat from the indoor air, and is condensed in the outdoor unit to emit heat. Also, the refrigerant flows between the indoor and outdoor units through the refrigerant flow channel.

When the air conditioner is applied to an air conditioning system for buildings, the overall length of pipes forming the refrigerant flow channel is greatly increased. If such long flow channel is to be disposed in the building, it is necessary that a plurality of pipes be connected to one another by welding to form a desired flow channel. In this case, foreign matter, such as sludge, may be separated from welding portions of the connected pipes, and then flow through the refrigerant flow channel together with the refrigerant.

When the foreign matter flows through the refrigerant flow channel together with the refrigerant as described above, the foreign matter may be accumulated in some parts of the refrigerant flow channel. As a result, the refrigerant may not smoothly flow through the refrigerant flow channel, or the refrigerant flow channel may even become clogged, and therefore, the air conditioner may malfunction. Especially when the foreign matter is accumulated in moving parts of the air conditioner, such as a compressor, the moving parts may malfunction and even be worn, which seriously deteriorates performance and reliability of the air conditioner.

For this reason, the air conditioner includes a refrigerant filtering apparatus disposed on the refrigerant flow channel for filtering refrigerant to remove the foreign matter therefrom. The refrigerant filtering apparatus generally comprises a filtering net, having meshes of a predetermined size, mounted in the refrigerant flow channel for filtering refrigerant, which flows through the refrigerant flow channel, to remove foreign matter larger than the size of the meshes of the filtering net.

When the foreign matter is excessively accumulated on the filtering net with the result that the filtering net is clogged to a considerable degree, however, flow resistance of the refrigerant is increased. As a result, operation efficiency of the air conditioner is lowered. According to circumstances, the filtering net may even be torn.

The speed of the refrigerant flowing through the refrigerant flow channel is highest at the center of the refrigerant. When foreign matter is accumulated on the center part of the filtering net, flow resistance of the refrigerant is further increased. Furthermore, pressure load applied to the filtering net is greatly increased.

### SUMMARY OF THE INVENTION

Accordingly, the present invention is directed to a refrigerant filtering apparatus for air conditioners that substantially obviates one or more problems due to limitations and disadvantages of the related art.

An object of the present invention is to provide a refrigerant filtering apparatus for air conditioners that is capable of reducing pressure load applied to a filtering net and reducing flow resistance of refrigerant due to foreign matter accumulated on the filtering net, and therefore, preventing deterioration of operation efficiency of the air conditioner.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a refrigerant filtering apparatus for air conditioners comprises: a refrigerant flow channel; and a filtering net mounted in the refrigerant flow channel such that a central part of the filtering net is placed at the upstream side in the refrigerant flow direction while a circumferential part of the filtering net is placed at the downstream side in the refrigerant flow direction.

Preferably, the refrigerant filtering apparatus further comprises: a filtering net fixing member for fixing the circumferential part of the filtering net to an inner circumferential surface of the refrigerant flow channel. The filtering net fixing member is formed in the shape of a ring. Also, the filtering net fixing member is securely fixed to the inner circumferential surface of the refrigerant flow channel.

Preferably, the refrigerant filtering apparatus further comprises: a filtering net supporting member for supporting the central part of the filtering net. The filtering net supporting member comprises: a rim fixed to the inner circumferential surface of the refrigerant flow channel; a holder for holding the central part of the filtering net; and a rib connected between the rim and the holder for supporting the holder. The holder is formed in the shape of a cone to minimize flow resistance of the refrigerant.

Preferably, the refrigerant filtering apparatus further comprises: foreign matter discharging means for discharging the foreign matter separated from the refrigerant by the filtering net from the refrigerant flow channel. The foreign matter discharging means comprises: a sludge cup for collecting the foreign matter separated from the refrigerant by the filtering net, the sludge cup being constructed such that the collected foreign matter can be discharged from the refrigerant flow channel; and a valve for selectively allowing and interrupting communication between the sludge cup and the refrigerant flow channel.

Preferably, the sludge cup is detachably attached to the refrigerant flow channel. Also preferably, the foreign matter discharging means is mounted at a bottom surface of the refrigerant flow channel adjacent to the connection between the circumferential part of the filtering net and the inner circumferential surface of the refrigerant flow channel such that the foreign matter separated from the refrigerant by the filtering net drops into the foreign matter discharging means due to gravity.

In another aspect of the present invention, a refrigerant filtering apparatus for air conditioners comprises: a refrigerant flow channel; and a filtering net, having a net structure, mounted in the refrigerant flow channel for filtering refrigerant to separate foreign matter therefrom, the filtering net being constructed such that the foreign matter separated from the refrigerant is gathered in the vicinity of the connection between the filtering net and an inner circumferential surface of the refrigerant flow channel.

Preferably, the filtering net is formed in the shape of a cone. The filtering net is mounted in the refrigerant flow channel such that an apex part of the filtering net is placed at the upstream side in the refrigerant flow direction while a circumferential part of the filtering net is placed at the downstream side in the refrigerant flow direction. Also preferably, the refrigerant filtering apparatus further comprises: a filtering net fixing member for fixing a circumferential part of the filtering net to the inner circumferential surface of the refrigerant flow channel. The filtering net fixing member is formed in the shape of a ring, which is securely fixed to the inner circumferential surface of the refrigerant flow channel.

Preferably, the refrigerant filtering apparatus further comprises: a filtering net supporting member for supporting the apex part of the filtering net. The filtering net supporting member comprises: a rim fixed to the inner circumferential surface of the refrigerant flow channel; a holder for holding the apex part of the filtering net; and a rib connected between the rim and the holder for supporting the holder. Also preferably, the refrigerant filtering apparatus further comprises: a filtering net fixing member for fixedly mounting the filtering net in the refrigerant flow channel and supporting the apex part of the filtering net. The filtering net fixing member comprises: a rim for fixing the circumferential part of the filtering net to the inner circumferential surface of the refrigerant flow channel; and ribs extending from the rim in a shape corresponding to the filtering net for supporting the filtering net.

Preferably, the refrigerant filtering apparatus further comprises: foreign matter discharging means for discharging the foreign matter separated from the refrigerant by the filtering net from the refrigerant flow channel. The foreign matter discharging means comprises: a sludge cup for collecting the foreign matter separated from the refrigerant by the filtering net, the sludge cup being detachably attached to the refrigerant flow channel; and a valve for selectively allowing and interrupting communication between the sludge cup and the refrigerant flow channel.

In yet another aspect of the present invention, a refrigerant filtering apparatus for air conditioners comprises: a refrigerant flow channel; a filtering net formed in the shape of a cone and mounted in the refrigerant flow channel, such that an apex part of the filtering net is placed at the upstream side in the refrigerant flow direction while a circumferential part of the filtering net is placed at the downstream side in the refrigerant flow direction, for filtering refrigerant to separate foreign matter therefrom, the filtering net being constructed such that the foreign matter separated from the refrigerant is gathered in the vicinity of the connection between the circumferential part of the filtering net and an inner circumferential surface of the refrigerant flow channel; and a sludge cup for collecting the foreign matter separated from the refrigerant by the filtering net, the sludge cup being detachably attached to the refrigerant flow channel.

Preferably, the refrigerant filtering apparatus further comprises: a filtering net fixing member for fixing the circumferential part of the filtering net to the inner circumferential surface of the refrigerant flow channel. The filtering net fixing member is formed in the shape of a ring. Preferably, the filtering net fixing member is securely fixed to the inner circumferential surface of the refrigerant flow channel.

Preferably, the refrigerant filtering apparatus further comprises: a filtering net supporting member for supporting the apex part of the filtering net. The filtering net supporting member comprises: a rim fixed to the inner circumferential surface of the refrigerant flow channel; a holder for holding the apex part of the filtering net; and a rib connected between the rim and the holder for supporting the holder.

Preferably, the refrigerant filtering apparatus further comprises: a filtering net fixing member for fixedly mounting the filtering net in the refrigerant flow channel and supporting the apex part of the filtering net. The filtering net fixing member comprises: a rim for fixing the circumferential part of the filtering net to the inner circumferential surface of the refrigerant flow channel; and ribs extending from the rim in a shape corresponding to the filtering net for supporting the filtering net.

Preferably, the refrigerant filtering apparatus further comprises: a valve for selectively allowing and interrupting communication between the sludge cup and the refrigerant flow channel. Also preferably, the sludge is mounted at a bottom surface of the refrigerant flow channel adjacent to the connection between the circumferential part of the filtering net and the inner circumferential surface of the refrigerant flow channel such that the foreign matter gathered in the vicinity of the connection between the circumferential part of the filtering net and the inner circumferential surface of the refrigerant flow channel drops into the sludge cup due to gravity.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a sectional view illustrating the structure of a refrigerant filtering apparatus for air conditioners according to the present invention;

FIG. 2 is a front view illustrating the filtering net fixing member of FIG. 1;

FIG. 3 is a perspective view illustrating the filtering net supporting member of FIG. 1;

FIG. 4 is a perspective view illustrating another example of the filtering net fixing member of refrigerant filtering apparatus for air conditioners according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

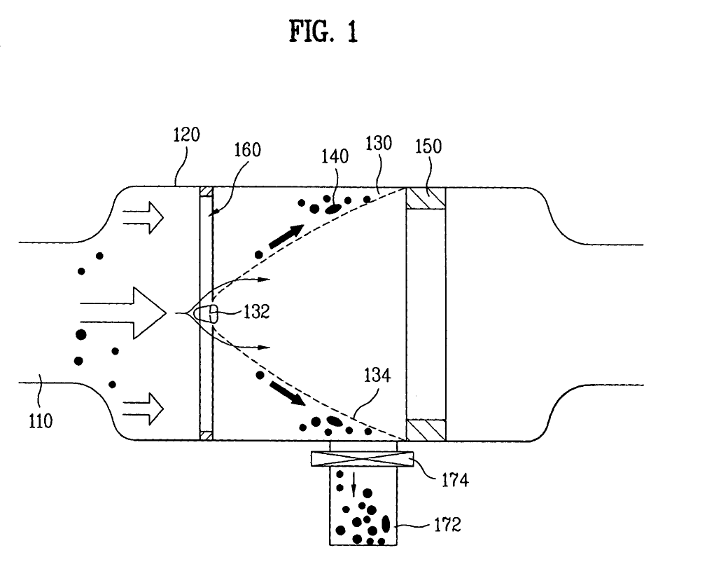

A refrigerant filtering apparatus for air conditioners according to the present invention will be described hereinafter in detail with reference to FIGS. 1 to 3. Referring first to FIG. 1, a filtering net 130 having a net structure is mounted in a refrigerant flow channel 120 for filtering refrigerant to remove foreign matter therefrom. Preferably, a central part 132 of the filtering net 130 is placed at the upstream side in the refrigerant flow direction while a circumferential part 134 of the filtering net 130 is placed at the downstream side in the refrigerant flow direction. Consequently, foreign matter 140 separated from refrigerant by the filtering net 130 moves toward the connection between the circumferential part 134 of the filtering net 130 and the inner circumferential surface of the refrigerant flow channel 120.

Specifically, the filtering net 130 is formed in the shape of a cone, the central part of which is protruded. Hereinafter, the protruded central part 132 of the filtering net 130 is referred to as an apex part 132 of the filtering net 130. Preferably, the apex part 132 of the conical filtering net 130 is placed toward the upstream side in the refrigerant flow direction.

When foreign matter 140 is accumulated on the filtering net 130, the sectional size of the refrigerant flow channel 120 is decreased. As a result, flow resistance of the refrigerant is increased. In order to prevent excessive increase of flow resistance of the refrigerant, the refrigerant flow channel 120 is preferably constructed such that the inner diameter of the refrigerant flow channel 120 where the filtering net 130 is mounted is greater than that of other parts of the refrigerant flow channel 120.

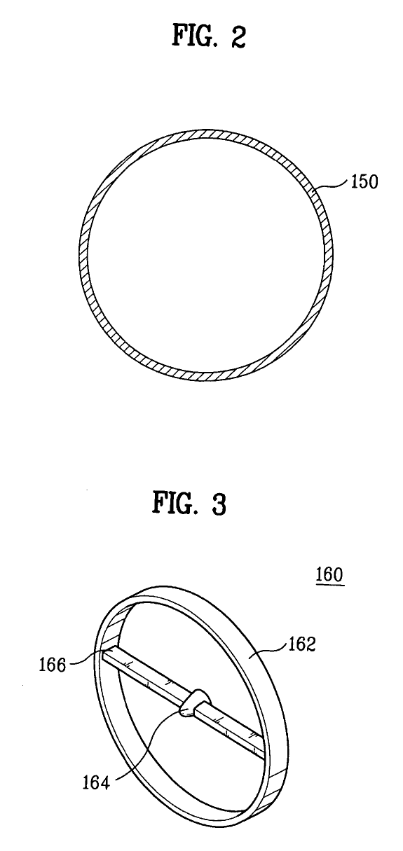

The circumferential part 134 of the filtering net 130 is fixed to the inner circumferential surface of the refrigerant flow channel 120 by means of a filtering net fixing member 150. When the entire circumferential part 134 of the circumferential filtering net 130 is not brought into tight contact with the inner circumferential surface of the refrigerant flow channel 120, the filtering net 130 does not perfectly fulfill its filtering function. For this reason, as shown in FIG. 2, the filtering net fixing member 150 is formed in the shape of a ring, which is securely fixed to the inner circumferential surface of the refrigerant flow channel 120. In this case, the circumferential part 134 of the filtering net 130 is interposed between the ring-shaped filtering net fixing member 150 and the inner circumferential surface of the refrigerant flow channel 120.

When the apex part 132 of the conical filtering net 130 is placed toward the upstream side in the refrigerant flow direction, the conical filtering net 130 having the net structure may be crushed due to flow pressure of the refrigerant. As a result, the conical shape of the filtering net 130 may be deformed. For this reason, the apex part 132 of the conical filtering net 130 is preferably supported by a filtering net supporting member 160.

As shown in FIG. 3, the filtering net supporting member 160 comprises: a rim 162 fixed to the inner circumferential surface of the refrigerant flow channel 120; a holder 164 for holding the apex part 132 of the filtering net 130; and a rib 166 connected between the rim 162 and the holder 164 for supporting the holder 164. As described above, the rim 162 is fixed to the inner circumferential surface of the refrigerant flow channel 120. Consequently, the rim 162 is preferably formed in the shape of a ring.

The holder 164 serves to hold the apex part 132 of the conical filtering net 130. Preferably, the holder 164 is formed in shape and size to minimize flow resistance of the refrigerant. In the illustrated embodiment, the holder 164 is formed in the shape of a cone. The rib 166 is connected between the rim 162 and the holder 164 for supporting the holder 164. Preferably, at least one rib is connected between the rim 162 and the holder 164, and the rib 166 is formed in shape to minimize flow resistance of the refrigerant.

In the illustrated embodiment, the filtering net 130 is formed in the shape of a cone. The circumferential part 134 of the filtering net 130 is fixed to the inner circumferential surface of the refrigerant flow channel 120 by the filtering net fixing member 150. The apex part 132 of the filtering net 130 is supported by the filtering net supporting member 160. Consequently, the shape of the filtering net 130 is not deformed.

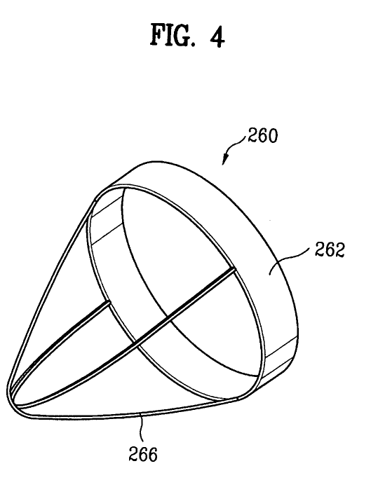

As described above, the filtering net 130 is fixed by the filtering net fixing member 150, and supported by the filtering net supporting member 160. Alternatively, the filtering net 130 may be simultaneously fixed and supported by a filtering net fixing member 260. The filtering net fixing member 260 is illustrated in FIG. 4.

As shown in FIG. 4, the filtering net fixing member 260 comprises: a rim 262 for fixing the circumferential part 134 of the filtering net 130 (see FIG. 1) to the inner circumferential surface of the refrigerant flow channel 120 (see FIG. 1); and ribs 266 extending from the rim 262 in the shape of a parabola such that the ribs 266 correspond to the conical shape of the filtering net 130. As in the previous embodiment, the circumferential part 134 of the filtering net 130 is preferably interposed between the ring-shaped outer circumferential surface of the rim 262 and the inner circumferential surface of the refrigerant flow channel 120.

The ribs 266 extend from the rim 262 in the shape of a parabola such that the ribs 266 correspond to the conical shape of the filtering net 130. Consequently, the conical shape of the filtering net 130 is prevented from being deformed due to flow resistance of the refrigerant. The filtering net 130 can be simultaneously fixed and maintained in shape by the filtering net fixing member 260.

The operation of the refrigerant filtering apparatus for air conditioners according to the present invention will now be described. In the following description, the refrigerant filtering apparatus includes the filtering net fixing member 150 and the filtering net supporting member 160.

As shown in FIG. 1, the foreign matter 140, such as sludge, flowing through the refrigerant flow channel 120 while being contained in refrigerant, are separated from the refrigerant by the filtering net 130. Since the filtering net 130 is formed in the shape of a cone, the foreign matter 140 separated from the refrigerant by the filtering net 130 moves toward the connection between the circumferential part 134 of the filtering net 130 and the inner circumferential surface of the refrigerant flow channel 120 along the inclined surface of the filtering net 130. The apex part 132 of the filtering net 130 is supported by the filtering net supporting member 160. Consequently, deformation in shape of the filtering net 130 due to flow pressure of the refrigerant is effectively prevented.

As the foreign matter 140 are moved toward the connection between the circumferential part 134 of the filtering net 130 and the inner circumferential surface of the refrigerant flow channel 120, the foreign matter 140 are not accumulated on the central part of the filtering net 130. As a result, flow resistance of the refrigerant is reduced, and therefore, pressure load applied to the filtering net 130 is also reduced. Furthermore, the surface area of the filtering net 130 is increased, since the filtering net 130 is formed in the shape of a cone. Consequently, pressure load applied to the filtering net 130 is further reduced.

Also, flow speed of the refrigerant at the connection between the circumferential part 134 of the filtering net 130 and the inner circumferential surface of the refrigerant flow channel 120, where the foreign matter 140, such as sludge, is gathered, is lower than that of the refrigerant at the center of the refrigerant flow channel 120. Consequently, adhesion of the foreign matter 140, such as sludge, to the inner circumferential surface of the refrigerant flow channel 120 is decreased.

According to the present invention, the refrigerant filtering apparatus further comprises foreign matter discharging means for discharging the foreign matter 140 gathered in the vicinity of the connection between the circumferential part 134 of the filtering net 130 and the inner circumferential surface of the refrigerant flow channel 120 from the refrigerant flow channel 120. Preferably, the foreign matter discharging means is disposed under the refrigerant flow channel 120 adjacent to the connection between the circumferential part 134 of the filtering net 130 and the inner circumferential surface of the refrigerant flow channel 120. The foreign matter discharging means will be described hereinafter in more detail.

As shown in FIG. 1, the foreign matter discharging means comprises a sludge cup 172 and a valve 174. The sludge cup 172 is mounted at the bottom surface of the refrigerant flow channel 120 adjacent to the connection between the circumferential part 134 of the filtering net 130 and the inner circumferential surface of the refrigerant flow channel 120. The valve 174 serves to selectively allow and interrupt communication between the sludge cup 172 and the refrigerant flow channel 120.

The sludge cup 172 communicates with the refrigerant flow channel 120. Consequently, the foreign matter separated from the refrigerant by the filtering net 130 in the refrigerant flow channel 120 is collected in the sludge cup 172. Preferably, the sludge cup 172 is detachably attached to the refrigerant flow channel 120. Alternatively, the sludge cup 172 may be opened such that the foreign matter 140 collected in the sludge cup 172 can be discharged out of the sludge cup 172. In the following description, the sludge cup 172 is detachably attached to the refrigerant flow channel 120.

The valve 174 is mounted at the connection between the sludge cup 172 and the refrigerant flow channel 120 for selectively allowing and interrupting communication between the sludge cup 172 and the refrigerant flow channel 120. The valve 174 serves to close the connection between the sludge cup 172 and the refrigerant flow channel 120 when the sludge cup 174 is detached from the refrigerant flow channel 120. Consequently, the refrigerant is prevented from leaking through the connection between the sludge cup 172 and the refrigerant flow channel 120 by means of the valve 174.

Since the filtering net 130 is formed in the shape of a cone, the foreign matter 140, such as sludge, is gathered in the vicinity of the connection between the circumferential part 134 of the filtering net 130 and the inner circumferential surface of the refrigerant flow channel 120. The gathered foreign matter 140 drops toward the bottom surface of the refrigerant flow channel 120 along the circumferential part 134 of the filtering net 130 due to gravity. The sludge cup 172 is mounted at the bottom surface of the refrigerant flow channel 120. Consequently, the dropped foreign matter 140 is collected in the sludge cup 172.

When the filtering net 130 is to be cleaned, the valve 174 is turned off, and then the sludge cup 172 is detached from the refrigerant flow channel 120. At this time, the valve 174 is closed, and therefore, the refrigerant does not leak out through the valve 174. After the foreign matter 140, such as sludge, is removed from the sludge cup 172, the sludge cup 172 is attached again to the refrigerant flow channel 120, and then the valve 174 is turned on. In this way, cleaning of the filtering net 130 is completed.

The refrigerant filtering apparatus for air conditioners according to the present invention has the following effects. Foreign matter is not accumulated on the central part of the filtering net where the speed of the refrigerant flowing through the refrigerant flow channel is the highest. Consequently, flow resistance of the refrigerant is reduced, and therefore, pressure load applied to the filtering net is also reduced.

The filtering net is formed in the shape of a cone, and therefore, the surface area of the filtering net is increased. Consequently, pressure load applied to the filtering net is further reduced. Furthermore, flow speed of the refrigerant at the connection between the circumferential part of the filtering net and the inner circumferential surface of the refrigerant flow channel, where the foreign matter, such as sludge, is gathered, is lower than that of the refrigerant at the center of the refrigerant flow channel. Consequently, adhesion of the foreign matter, such as sludge, to the inner circumferential surface of the refrigerant flow channel is decreased.

The foreign matter separated from the refrigerant by the filtering net drops into the sludge cup. Consequently, the filtering net is maintained clean. When the refrigerant filtering apparatus is to be cleaned, the sludge cup is detached from the refrigerant flow channel, and then the sludge cup is emptied. Consequently, cleaning of the refrigerant filtering apparatus is very easy, and therefore, time necessary to clean the refrigerant filtering apparatus is reduced, and reliability of the refrigerant filtering apparatus is improved.

When the refrigerant filtering apparatus is to be cleaned, the valve is turned off, and then the sludge cup is detached from the refrigerant flow channel. Consequently, it is not necessary to suspend the operation of the air conditioner. Furthermore, cleaning of the refrigerant filtering apparatus is possible without removing the refrigerant from the refrigerant flow channel. Consequently, maintenance of the air conditioner is easily performed, and therefore, time and costs necessary for the maintenance are reduced.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A refrigerant filtering apparatus for air conditioners, comprising:
a refrigerant flow channel; and
a filtering net mounted in the refrigerant flow channel such that a central part of the filtering net is placed at the upstream side in the refrigerant flow direction while a circumferential part of the filtering net is placed at the downstream side in the refrigerant flow direction.

2. The apparatus as set forth in claim 1, further comprising:
a filtering net fixing member for fixing the circumferential part of the filtering net to an inner circumferential surface of the refrigerant flow channel.

3. The apparatus as set forth in claim 2, wherein the filtering net fixing member is formed in the shape of a ring, which is securely fixed to the inner circumferential surface of the refrigerant flow channel.

4. The apparatus as set forth in claim 1, further comprising:
a filtering net supporting member for supporting the central part of the filtering net.

5. The apparatus as set forth in claim 4, wherein the filtering net supporting member comprises:
a rim fixed to the inner circumferential surface of the refrigerant flow channel;
a holder for holding the central part of the filtering net; and
a rib connected between the rim and the holder for supporting the holder.

6. The apparatus as set forth in claim 5, wherein the holder is formed in the shape of a cone to minimize flow resistance of the refrigerant.

7. The apparatus as set forth in claim 1, further comprising:
foreign matter discharging means for discharging the foreign matter separated from the refrigerant by the filtering net from the refrigerant flow channel.

8. The apparatus as set forth in claim 7, wherein the foreign matter discharging means comprises:
a sludge cup for collecting the foreign matter separated from the refrigerant by the filtering net, the sludge cup being constructed such that the collected foreign matter can be discharged from the refrigerant flow channel; and
a valve for selectively allowing and interrupting communication between the sludge cup and the refrigerant flow channel.

9. The apparatus as set forth in claim 8, wherein the sludge cup is detachably attached to the refrigerant flow channel.

10. The apparatus as set forth in claim 7, wherein the foreign matter discharging means is mounted at a bottom surface of the refrigerant flow channel adjacent to the connection between the circumferential part of the filtering net and the inner circumferential surface of the refrigerant flow channel such that the foreign matter separated from the refrigerant by the filtering net drops into the foreign matter discharging means due to gravity.

11. A refrigerant filtering apparatus for air conditioners, comprising:
a refrigerant flow channel; and
a filtering net, having a net structure, mounted in the refrigerant flow channel for filtering refrigerant to separate foreign matter therefrom, the filtering net being constructed such that the foreign matter separated from the refrigerant is gathered in the vicinity of the connection between the filtering net and an inner circumferential surface of the refrigerant flow channel.

12. The apparatus as set forth in claim 11, wherein the filtering net is formed in the shape of a cone, and the filtering net is mounted in the refrigerant flow channel such that an apex part of the filtering net is placed at the upstream side in the refrigerant flow direction while a circumferential part of the filtering net is placed at the downstream side in the refrigerant flow direction.

13. The apparatus as set forth in claim 11, further comprising:
a filtering net fixing member for fixing a circumferential part of the filtering net to the inner circumferential surface of the refrigerant flow channel.

14. The apparatus as set forth in claim 13, wherein the filtering net fixing member is formed in the shape of a ring, which is securely fixed to the inner circumferential surface of the refrigerant flow channel.

15. The apparatus as set forth in claim 12, further comprising:
a filtering net supporting member for supporting the apex part of the filtering net.

16. The apparatus as set forth in claim 15, wherein the filtering net supporting member comprises:
a rim fixed to the inner circumferential surface of the refrigerant flow channel;
a holder for holding the apex part of the filtering net; and
a rib connected between the rim and the holder for supporting the holder.

17. The apparatus as set forth in claim 12, further comprising:
a filtering net fixing member for fixedly mounting the filtering net in the refrigerant flow channel and supporting the apex part of the filtering net.

18. The apparatus as set forth in claim 17, wherein the filtering net fixing member comprises:
a rim for fixing the circumferential part of the filtering net to the inner circumferential surface of the refrigerant flow channel; and
ribs extending from the rim in a shape corresponding to the filtering net for supporting the filtering net.

19. The apparatus as set forth in claim 11, further comprising:
foreign matter discharging means for discharging the foreign matter separated from the refrigerant by the filtering net from the refrigerant flow channel.

20. The apparatus as set forth in claim 19, wherein the foreign matter discharging means comprises:
a sludge cup for collecting the foreign matter separated from the refrigerant by the filtering net, the sludge cup being detachably attached to the refrigerant flow channel; and
a valve for selectively allowing and interrupting communication between the sludge cup and the refrigerant flow channel.
